(19) United States
(12) Patent Application Publication
(10) Pub. No.: US 2018/0004845 A1
(43) Pub. Date: Jan. 4, 2018

(54) Web Based Information Search Method

(71) Applicant: Carlos A. Munoz, Phoenix, AZ (US)

(72) Inventor: Carlos A. Munoz, Phoenix, AZ (US)

(21) Appl. No.: 14/885,989

(22) Filed: Oct. 16, 2015

(51) Int. Cl. G06F 17/30; G06Q 30/02; G06Q 30/06

(52) U.S. Cl. CPC G06F 17/30867; G06F 17/3087; G06Q 30/0256; G06F 17/30554; G06F 17/30672; G06Q 30/0601

(57) ABSTRACT

The present invention is a web-based and mobile device application service that enables customizable product or service information retrieval from the Internet through the input of a unique product or service identifier and a location parameter. The unique product or service identifier is an alpha numeric number, UPC code, SKU, MLS or other product or service identifying parameter and the location parameter, which may be a zip code, address, town, city, state, country, GPS coordinate, or other location identifier, to provide a user with listings of the exact locations of a product or service from or within the described location. The retrieved data may include information regarding the product or service, including but not limited to price, size, availability, product or service description, web site information or links, promotional codes or sale information or any other data made available by the seller. The system may further enable a user to input a common product or service name which is converted into a unique product or service identifier.

### I. TECHNICAL FIELD

The present invention relates to web-based personal and business information search systems and, more particularly, to a web-based and computing device personal and business information retrieval and sorting method and system using product or service information and location data.

### II. BACKGROUND OF THE INVENTION

The ubiquity of the Internet and the digitization of content and media have forever changed the way we communicate. While presenting new information classification and retrieval schemes for use by business to advertise and promote goods and services, and by consumers to locate those goods and services, it also presents new sets of data retrieval, conversion, delivery, and storage challenges.

More specifically, the Internet has developed into a system that relies almost exclusively on keyword searching and search engine ranking status to complete a search for information. Such a system has several shortcomings. First, search results may include thousands or millions of entries. A user must then review the results to find information relevant to them. This can lead to hours of data review, filtering, and potentially missed results. Too often, the results include a majority of irrelevant entries. Second, keyword searching ultimately reaches an effectiveness limit after which further refinement or gains are not realizable or are only insignificant incremental changes. Moreover, there is no opportunity for ranking data based upon user input factors, such as price, distance to location, size, sales, etc. Instead, the user is left with a list of keyword matches. Even in the instance where there is local listing, it is not rank by user preference but instead by organic growth of a site's popularity or, more often, whoever pays the most for a keyword.

Further, current systems generally drive a user to a particular web site where they must look for the product, see if it meets the user's criteria, and, typically make a separate inquiry into availability.

Confirmation of the shortcomings of current search functionality comes from industry insiders. Recently, the CEO of a major web based company stated that search has only been about five percent (5%) figured out.

There is need, therefore, for a web based system that enables a user to readily and accurately retrieve desired information form the Internet. Such a system should also enable customized packets of information tailored to a user's requirements. Further, such a system will enable a seller of goods or services to offer a coded description of goods or services that do not require a user to do additional searching. The present invention provides such a solution.

### III. SUMMARY OF THE INVENTION

The present invention is a web-based search method that enables information retrieval and dissemination based upon user input of a product or service code and any combination of location data and or parameters provided as part of the search process via input or retrieval. A product or service code may include any identifier that will retrieve the desired product or service, such as a universal pricing code (UPC), a stock keeping unit (SKU), multiple listing service number (MLS), or any other standardized coding system, including one designed for the current invention. A location identifier can be a zip code, address, global positioning system coordinate (GPS), town, city, street, state, country, address name (e.g., distribution warehouse, bank), or other location identifying system. A seller of goods or services may upload to the Internet information regarding their goods or services in a variety of ways (product or service code). The information may be a general listing but may also be a unique encrypted alpha numeric hash. The hash creation may involve the steps of compiling data for dissemination. Such data can include anything a seller wishes a consumer to know about the product or service such as product name, size, product codes such as, but not limited to, UPC, EAN, GTIN, and SKU, service description, sales and promotion information, availability, direction for taking advantage of a promotion, facility location information like GPS, street address, map coordinates, store number or email address, and social media information. The foregoing is not meant to be an exhaustive list of possibilities but is, instead, for example purposes only; data can include virtually anything the seller wants to disseminate on the Internet. Data may then be converted into a standard code, or tag, such as a QR code. This code is then converted to a unique numeric value which, in turn is converted into a unique alpha numeric hash.

In use, a seller would upload data to the Internet. A user wishing to access data about a particular product or service would access the Internet with a computing device and then access the inventive application (app). A user then inputs the product or service code followed by a location identifier. After hitting a search function, results are displayed based upon the search parameters.

Displayed results may be sorted by user preference. Non-limiting examples of sorting may include distance from current or specified location, store, price, sales or promotion availability, product or service availability, or size.

Activating a particular entry may bring the user to a store or product web site or page that could describe in more detail the product or service or location information.

Items of interest to a user may be stored as favorites or sent to a list. Using a social media function, an item or list of items may be published by the user. A user may also delete items or lists.

The inventive method can work as a stand-alone feature, part of a web search function, in an application format, or other environment. As those skilled in the arts will quickly understand, the inventive method can be used in a multitude of web environments.

### IV. BRIEF DESCRIPTION OF THE DRAWINGS

FIG. 1 is a flow chart depicting a general overview of the process in using the system.

FIG. 2 is an illustration depicting a representative example of an application registration screen.

FIG. 3 is a flow chart depicting a general overview of a typical search employing the inventive method.

FIG. 4-FIG. 4D illustrates screen shots of a search using current search engine technology and a search employing the inventive method.

FIG. 5A-5B illustrates screen shots of a search using current social media search engine technology and a search employing the inventive method.

FIG. 6A-6B illustrates screen shots of an additional example search using current search engine technology and a search employing the inventive method.

### V. DETAILED DESCRIPTION OF THE INVENTION

Before explaining the preferred embodiment of the present invention in detail, it is to be understood that the present invention is not limited in its application to the details of arrangements of the components set forth in the following description. As will be appreciated by those skilled in the arts, the present invention is capable of other embodiments and of being practiced and carried out in various ways. Also, it is to be understood that the phraseology and terminology employed herein are for the purpose of description and should not be regarded as limiting. It is also to be understood that where ranges are provided for various aspects of the invention and for examples, they are approximate ranges and are not to be limiting except where noted otherwise.

Unless defined otherwise, all technical and scientific terms used herein have the same meaning as commonly understood by one of ordinary skill in the art to which this invention belongs. Moreover, the singular forms “a”, “an”, and “the” include plural referents unless the context dictates otherwise. Use of the word “product” or “service” is meant to include both, unless the context dictates otherwise. The seller is meant to refer a person or entity wishing to promote, give away, sell, or otherwise dispose of a product or service. A user is meant to refer to a person or entity using the inventive system to locate information of interest regarding products or services.

Throughout, brand names of various Internet related companies and product names are used. These include but may not be limited to Yahoo!, Google, Facebook, instagram, Twitter, LinkedIn, Google+, Path, MySpace, Pinterest, and Frosted Flakes. Each of these is a trademark owner by its respective owner. The names are used for examples only. They are not meant to be limiting. No ownership or licensing position or endorsement by the owner of the inventive method is intended.

As those skilled in the arts will understand, the flowcharts referenced to herein are for illustration purposes only. They are meant to serve as an aid in describing the embodiments of the present invention, but are not meant to constrain implementation thereof to any particular hardware or software embodiments. They are also not meant to mean that any order of the steps as depicted is critical. In the drawings, the same reference letters are employed for designating the same elements throughout the several figures. The order of steps in a particular action is not critical to the use or novelty of the invention.

The present invention is a web-based method that allows information retrieval and dissemination based upon user input into a computing device of a product or service code and a location parameter. The inventive method can work as a stand-alone feature, part of a web search function, in an application format, or other environment. As those skilled in the arts will quickly understand, the inventive method can be used in a multitude of web environments.

A unique product or service code may include any identifier that will retrieve the desired product or service, such as a universal pricing code (UPC), a stock keeping unit (SKU), multiple listing service number (MLS), or any other standardized coding system, including a code designed for specific use under particular circumstances. A location identifier can be a zip code, global positioning system coordinate (GPS), town, city, street, state, country or other location identifying system. The location feature of a web enabled device may also be used to identify location.

A seller of goods or services may upload to the Internet information regarding their goods or services in a variety of ways. The information may be a general listing as may normally be seen on the web or it may include more detailed or encrypted information. For example, a seller may include a unique encrypted alpha numeric hash. The hash creation may involve the steps of compiling data for dissemination. Such data can include anything a seller wishers a consumer to know. Items may include, product name, size, UPC and SKU codes, service description, sales and promotion information, availability, direction for taking advantage of a promotion, facility location information like GPS, street address, map coordinates, store number or email address, and social media information. The foregoing is not meant to be limiting; data may include virtually anything the seller wants to disseminate on the Internet. Data is then converted into a standard code, or tag, such as a QR code. This code is then converted to a unique numeric value which, in turn may be converted into a unique alpha numeric hash. Alternatively, a seller may upload the data directly, without conversion into a standard code. Uploaded data, in any form, is referred herein to a product or service code.

In use, a seller would upload data to the Internet. A user wishing to access data about a particular product or service would access the Internet via a computing device. A user then inputs the product or service code followed by a location identifier. After hitting a search function, results are displayed based upon the search parameters.

In the case where a dedicated application (app) is used, the results may be sorted by user preference. Non-limiting examples of sorting may include distance from current or specified location, store, price, sales or promotion availability, product or service availability, or size.

Activating a particular entry may bring the user to a store or product web site or page that could describe in more detail the product or service or location information.

Items of interest to a user may be stored as favorites or sent to a list. Using a social media function, an item or list of items may be published by the user. A user may also delete items or lists.

Using the concepts of the present invention, individuals or business entities create data packets to share the most relevant information pertaining to a given situation.

This may be accomplished in a web-based and mobile device application system employing a file-sharing platform and mobile app for the searching, retrieval, viewing, sorting, storage and dissemination and recall of product and service information.

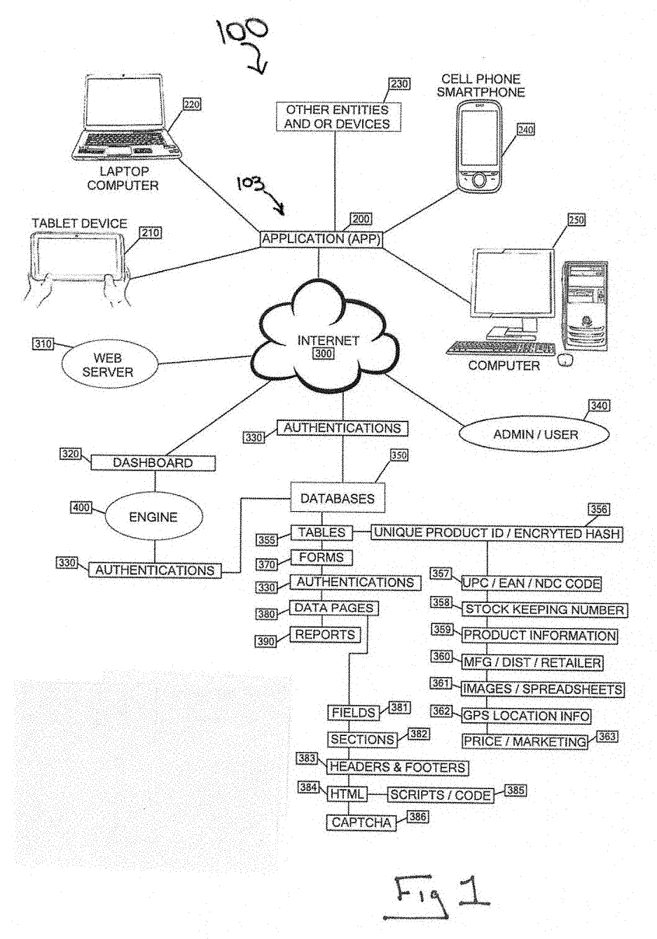

With reference to FIG. 1, a general overview of the inventive system 100 is depicted wherein a dedicated app system is employed wherein user 102 locally accesses 103 the inventive app 200 through use of a web enabled device such as a smartphone 240, tablet device 210, laptop computer 220, desktop computer 250 or other web enabled computing device 230. For purposes of the description herein, reference is made to a smartphone 240. However, this is not meant to limit the invention to such use as those skilled in the arts will understand. For purposes of the invention, certain activities described throughout may be better performed on a particular type of electronic equipment. For non-limiting example, a desktop 250 or laptop computer 220 may be better suited for retrieving, reviewing, sorting, and saving large amounts of data while a tablet 210 or smartphone 240 may be better suited for pinpointing a particular product or service or for sharing information on social media while the user is on the go. As should be understood, the electronic equipment used is not critical to the inventions principles; it is the access to the Internet 300 in order to access the app that is important.

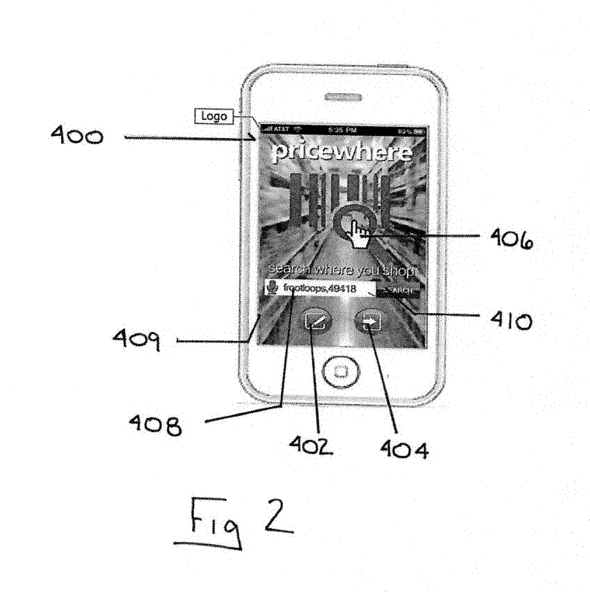

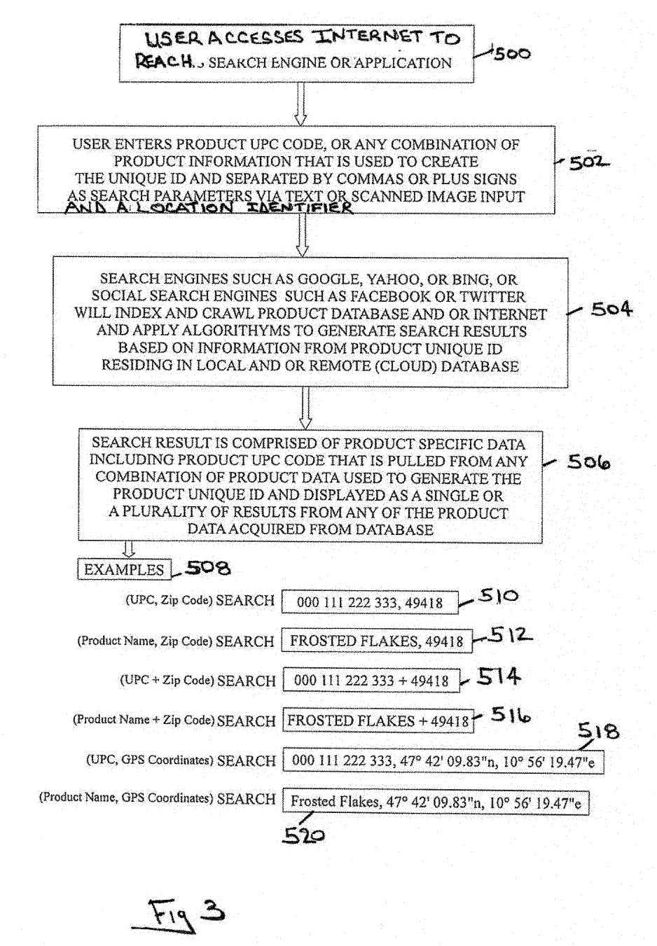

With reference to FIG. 2, once the user accesses the app through a web address specific to the network or mobile application icon specific to the network, the user is directed to a home screen 400. The home screen, as are all the screens of the inventive device (including the mobile application icon), is of a graphical user interface variety (GUI), and more particularly WIMP and post-WIMP interfaces. Many desktop and laptop devices continue to rely on WIMP interfaces, which also work with the present invention, but as these devices transition to post-WIMP interfaces they will be able to take advantage of the present invention also. Other interfaces may also be used in the inventive system including, without limitation, zooming interfaces, tangible interfaces, voice interfaces, and gesture (or pointing) interfaces. The flexibility of the inventive system accommodates virtually any interface as one principle of the inventive system is to collect disparate information for curation from unlimited electronic and digital sources. Moreover, the flexibility of the present invention is not affected by technology advances, and the inventors anticipate advances in technology will provide new opportunity for data collection, storage, and sharing under the principles of the invention.

Additionally, those skilled in the art will recognize that the program instructions for software applications implementing all or a portion of one or more embodiment(s) of the present invention may be written in a programming language such as, but not limited to, Java or C++, and that the database may be implemented with a database package such as Microsoft Access™, or a database management system (DBMS) such as Microsoft SQL Server™, Microsoft SQL Server CE™, IBM DB2™, mySQL or postgreSQL.

Moreover, and as will be appreciated by those skilled in the arts, information may located in many locations such as local hard drives, media formats, web located data storage accounts, social media accounts, servers, and intranet systems be found in various formats. Further, information data may be various formats such as media formats for video including, but are not limited to, DVD, CD, MP3, MP4, tapes, DVR, VCD, AFI, ASF, ASX, DivX, MPEG, MPG, MPE, SVCD, WMV, MOV, OGG, QT, RM, WMA, XVCD, XSVCD, AAC LD, HE-AAC, AAC ELD, AMR, RA, RAM, VOB, RIFF, AIF, MKV, FLV, JPEG, MPEG, and FLAC.

Turning again to FIG. 2, the home screen, here depicted on smartphone, includes register button 402 for use by the user to set up an account. Activating register button takes the user to the register page on which page the user may enter name, email address, and a password, and enters to register the account by pressing confirm registration, as is done in industry known registering systems. However, it is important to understand that registering an account is not critical to the function of the invention. Registering merely enables enhancement of the user experience with the invention. The principles of the invention work just as well without account registration.

Moreover, the registration process described above relies on an email address. As those skilled in the arts will understand, other registration and login methods can be used, such as a user name. The use of an email address, however, is preferred. In an embodiment wherein another login scheme is used, the system will ask for an email address if the user desires to take advantage of certain invention features.

Returning to FIG. 2, if the user has chosen to register an account, the account can be accessed through login icon 404. A user, whether or registered, can initiate a search through the home page. A user may activate scanning icon 406 which, in turn, activates a devices camera function for scanning a product code, such as a UPC bar code or SKU (throughout product code or a specific type of code may also be referred to as “unique product identifier”). This feature enables a user to retrieve product information from a remote location, such as at home, to, for example, see where the best location to replenish a certain item (e.g., cereal) is located. Alternatively, a user may be in a store and wants to see whether that store has the best price for a certain product.

The user has the alternative option of inputting by hand or voice 409 the unique product identifier into search bar 408. In addition to inputting a unique product identifier, the user inputs a location identifier. A location identifier may be a zip code, GPS coordinate, address, town or city, state, or even country. The more specific the location identifier, the more focused the search results will be. Once the unique product code and location identifier are input into the app, the search is initiated by activation search button 410. Moreover, location can be determined by the internal tracking device of the internet access device being used. For non-limiting example, the location feature of a smartphone may be used to set the location identifier.

If the user has not registered an account or the method is used as a stand alone function or part of a search function but instead wishes merely to search, a product or service code and location identifier may be entered into a browser's search bar.

A further advantage of the present invention is that the user may also store and share lists on social media. The principles of the present invention will accommodate any social media site or application, including, but not limited to, instagram, Twitter, LinkedIn, Google+, Path, MySpace, and Pinterest.

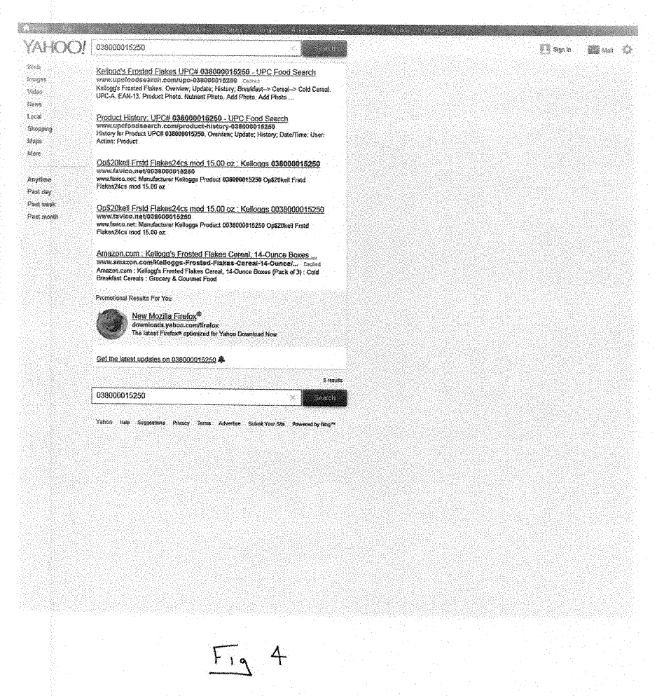

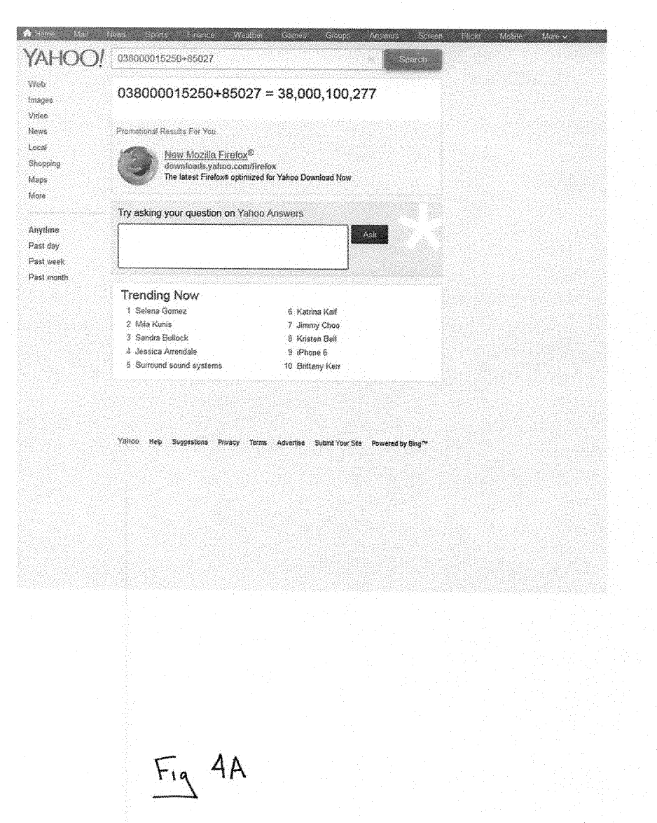

Turning to FIG. 3, a flowchart depicting a search using the inventive method is shown. As can be seen, a user accesses the internet to reach a search engine or application 500. The user thereafter enters a unique product identifier and location identifier 502. After pressing the search button, the search engine or application indexes and crawls the Internet using algorithms to generate search results 504. The results are thereafter displayed and include specific information as suggested by the search parameters 506. Examples of possible search terms comprising unique product identifiers and location identifiers are UPC and zip code (510, 514), product name and zip code (512, 516) UPC and GPS coordinate (518), and product name and GPS coordinate (520). These are non-limiting example of potential search terms using the inventive method and not meant to be limiting in any way. There are many other search term combination. It is only important that a unique product or service identifier and a location identifier are used.

Within each information category (or list), in addition to multiple sources of information, there may be multiple types of information. For example, purchase information may include type of product or service, quantity purchased, name of product or service, brand name of product or service, model number of product or service, serial number of product or service, store or merchant name, retail location, time and date, price, discounts, and warranty information.

In addition to sharing information with recipients over the Internet, the user may also use the information locally. The present invention enables a user to have a list that may have been gathered from multiple locations and may include test and examination results not often carried by patients to an appointment at their fingertips.

It should also be noted but obvious to those skilled in the arts that the screen layout and design of the data structures can vary greatly, depending on various factors such as the design requirements for the search provider and the selected platforms used to implement the system (e.g., DBMS, operating system, etc.). Further, the use of page headings are for illustration purposes only. As those skilled in the arts will understand, the page heading identifiers can be labeled anything and do not impact the function of the device or its principles of use.

In some embodiments, the user uses the GUI in order to provide mapping between output data feeds and those with whom the information is gathered or shared. Depending on the embodiment, the GUI may be presented on the screen of a personal computer or handheld device or on some other suitable display. In one embodiment, the user interface (UI), which may be a GUI or a text-based interface, may be presented on a computer display screen. Alternatively, the user interface may be presented on the display of a device, or on a smaller screen contained within a handheld device.

Alternatively, information regarding the mappings for the data feeds may be located in a configuration file. The configuration file may reside on a personal computer or server in a network (local or Internet).

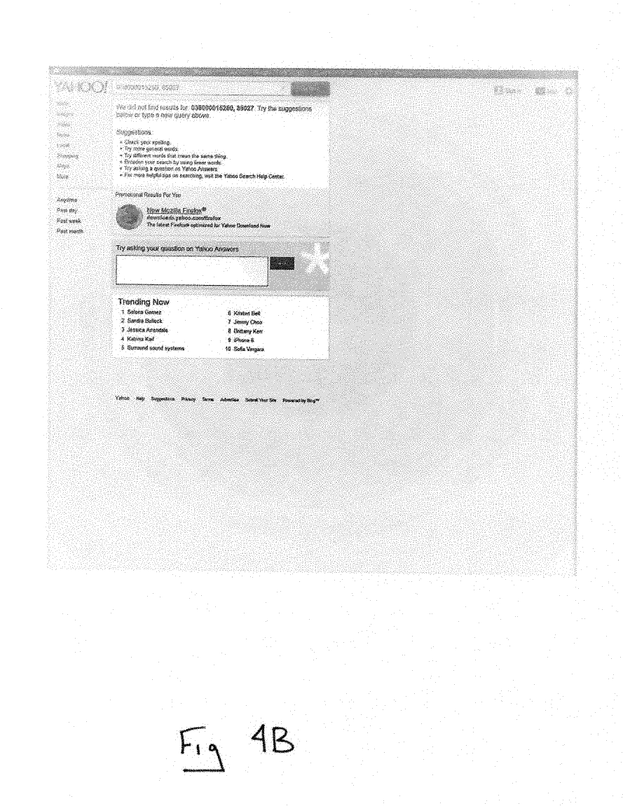

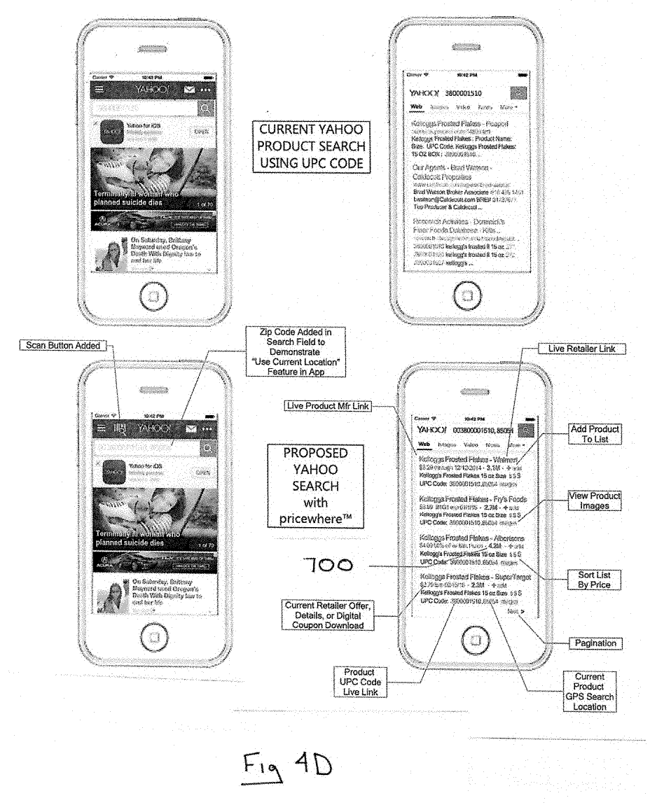

Examples of the inventive method are depicted in FIG. 4-FIG. 4D, 5A-5B, and 6A-6B. In FIG. 4-4D, a representative example using the search engine Yahoo!. As can be seen in FIGS. 4, 4A, B and 4C, searches incorporating only a product identifier (here a UPC code) yield disparate information regarding the product associated with the UPC code. No information regarding location is provided. In FIGS. 4A and 4B, adding a location identifier (here a zip code) by a plus sign (FIG. 4A) yield an addition of the numbers and by comma separation (FIG. 4B) yields no results. Turning to FIG. 4D, wherein the inventive method is used, yields results which are sorted by location proximity of the product 700.

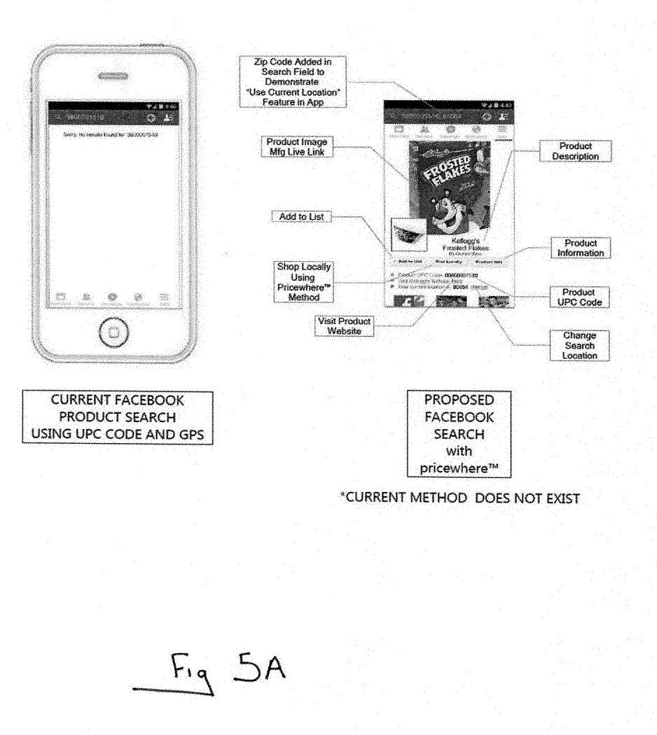

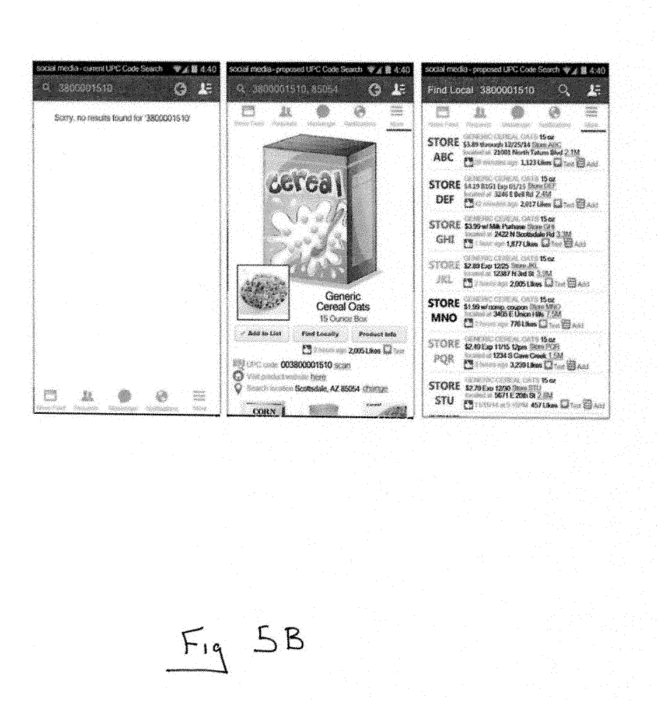

Turning to FIGS. 5A and 5B, a search using a social media platform, here Facebook, is depicted. Using only a product code (here a UPC code) yield no results. However, when employing the inventive method, product information and location is presented (FIG. 5B).

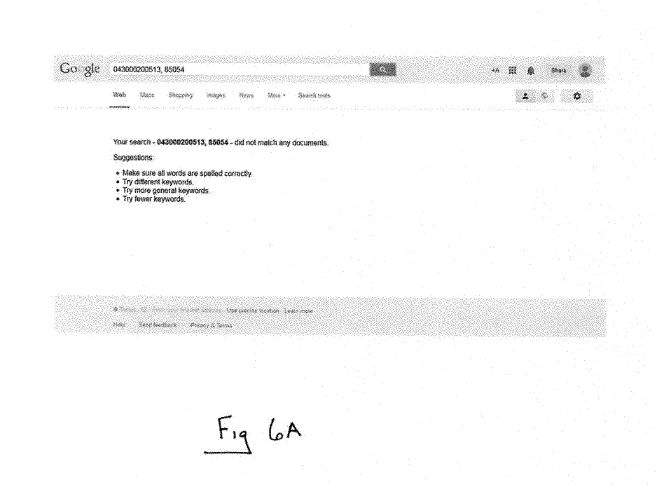

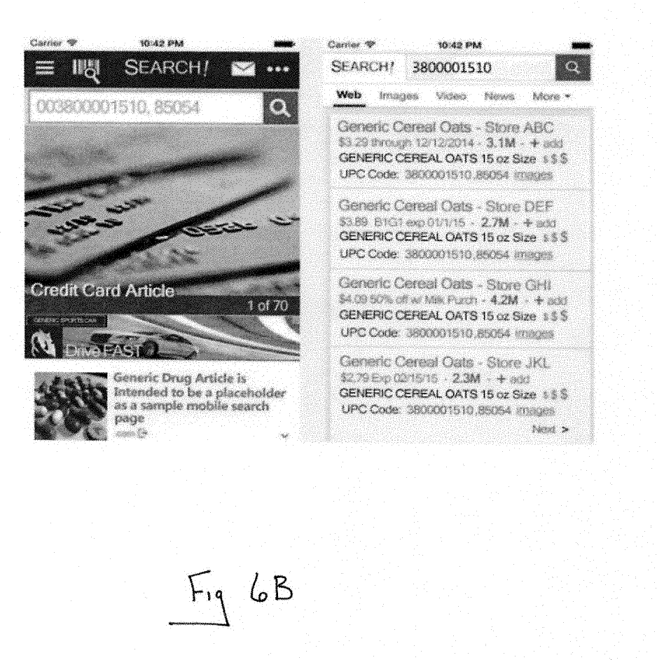

In a final representative example, FIGS. 6A and 6B depict a search using Google wherein FIG. 6A depicts a search using current technology in which a UPC code and a zip code are entered. The search reveals no results. In FIG. 6B, the inventive method search function is employed and the results yield product specific information, including location distance for the product.

The present invention may also be used to generate notifications to recipients based on the user's account information, if registered. An example of an event that might be contained in the user's account is product listings that generate notifications when the product goes on sale.

In another embodiment, a user's information may be a source of gathered information for generating personalized recommendations by businesses. For example, a user's past consumption habits and feedback that the user has shared regarding certain products or services, The vendor, a grocery store for example, may make food recommendations or notify the user of specials on certain food products the user is known to like from information previously stored searches.

As will also be understood by those skilled in the arts, the order of the steps of the method described above is not critical. The spirit of the invention and the method for employing it are found in the individual features of the invention and their use, not the order in which they are used or presented herein.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and aspects of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary aspects shown and described herein. Rather, the scope and spirit of present invention is embodied by the appended claims.

I claim:

1. A method for a web-based system of retrieving data from the Internet using a computing device including:
(a) accessing the Internet;
(b) contacting a remote, centralized web-based search function;
(c) accessing the search page of the remote, centralized web-based search function;
(d) imputing a unique product or service code and a location identifier into the remote, centralized web-based search function;
(e) activating a search function; and,
(f) retrieving search results based upon the search criteria.

2. The method of claim 1 wherein the unique product or service code is a standardized code.

3. The method of claim 1 wherein the unique product or service code is a user promulgated product descriptor, the product descriptor then converted into a standardized code.

4. The standardized code of claim 2 being selected from the group comprising but not limiting to, either singly or in combination, UPC, SKU, EAN, MLS, VIN, and GTIN.

5. The method of claim 1 wherein the location identifier is selected from the group comprising but not limed to, either singly or in combination, zip code, GPS coordinate, location, cellular triangulation, address, city, town, state, and country.

6. The method of claim 1 wherein the retrieved data includes information selected singly or in combination from the group comprising but not limited to product or service name, price, location name, distance to location, inventory count, product size, promotion information, availability, local competition, and coupons.

7. The method of claim 1 including the further step of sorting the retrieved search results to a user's preference.

8. The step of claim 7 wherein the user's preference is selected singly or in combination from the group comprising but not limited to product or service name, price, location name, distance to location, inventory count, product size, promotion information, availability, local competition, and coupons.

9. The method of claim 1 wherein the search function is contacted through the group comprising an app, Internet sharing via hardwired systems, Wi-Fi, QR code scanning uplink, application program interface (API), or near field communication.

10. The method of claim 1 including the further step of a seller of a product or service uploading to the Internet information regarding their goods or services using a unique encrypted alpha numeric hash or using a recognized industry standardized alpha numeric value, the hash creation including the further steps of compiling data for dissemination; converting the data into a standard code; converting the standard code into a unique numeric value; and converting the unique numeric value into a unique alpha numeric hash.

11. The method of claim 10 wherein the data for dissemination is selected singly or in combination from the group comprising but not limited to product name, size, UPC and SKU codes or industry standardized alpha numeric values, service description, sales and promotion information, availability, direction for taking advantage of a promotion, facility location information like GPS, street address, map coordinates, store number or email address, and social media information.

12. The method of claim 10 wherein the standard code is a tag.

13. The method of claim 1 including the further step of selecting one or more individual search results and adding them to a list.

14. The method of claim 1 including the further step of disseminating search results to but not limited to search engines and or social media.

15. The social media information of claim 14 wherein the social media is selected singly or in combination from the group comprising but not limiting to Facebook, Twitter, LinkedIn, Google+, Path, MySpace, Pinterest, browsers, and search engines.

16. A method for sharing data between a seller and a customer comprising:
(a) uploading data by a seller using a remote computing device to contact a web-based, centralized digital information site;
(b) accessing the Internet by a customer;
(c) contacting a remote, centralized web-based search function;
(d) accessing the search page of the remote, centralized web-based search function;
(e) imputing search criteria into the remote, centralized web-based search function, the search criteria comprising at least a unique product or service code and a location identifier;
(f) activating a search function; and,
(g) retrieving search results based upon the search criteria.

17. The method of claim 16 wherein the unique product or service code is a standardized code.

18. The method of claim 16 wherein the unique product or service code is a user promulgated product descriptor, the product descriptor then converted into a standardized code.

19. The standardized code of claim 17 being selected from the group comprising but not limiting to, either singly or in combination, UPC, SKU, EAN, MLS, VIN, and GTIN.

20. The method of claim 16 wherein the location identifier is selected from the group comprising but not limed to, either singly or in combination, zip code, GPS coordinate, location, cellular triangulation, address, city, town, state, and country.

21. The method of claim 16 wherein the retrieved data includes information selected singly or in combination from the group comprising but not limited to product or service name, price, location name, distance to location, inventory count, product size, promotion information, availability, local competition, and coupons.

22. The method of claim 16 including the further step of sorting the retrieved search results to a user's preference.

23. The step of claim 22 wherein the user's preference is selected singly or in combination from the group comprising but not limited to product or service name, price, location name, distance to location, inventory count, product size, promotion information, availability, local competition, and coupons.

24. The method of claim 16 wherein the search function is contacted through the group comprising an app, Internet sharing via hardwired systems, Wi-Fi, QR code scanning uplink, application program interface (API), or near field communication.

25. The method of claim 16 including the further step of a seller of a product or service uploading to the Internet information regarding their goods or services using a unique encrypted alpha numeric hash or using a recognized industry standardized alpha numeric value, the hash creation including the further steps of compiling data for dissemination; converting the data into a standard code; converting the standard code into a unique numeric value; and converting the unique numeric value into a unique alpha numeric hash.

26. The method of claim 25 wherein the data for dissemination is selected singly or in combination from the group comprising but not limited to product name, size, UPC and SKU codes or industry standardized alpha numeric values, service description, sales and promotion information, availability, direction for taking advantage of a promotion, facility location information like GPS, street address, map coordinates, store number or email address, and social media information.

27. The method of claim 26 wherein the standard code is a tag.

28. The method of claim 16 including the further step of selecting one or more individual search results and adding them to a list.

29. The method of claim 16 including the further step of disseminating search results to but not limited to search engines and or social media.

30. The social media information of claim 29 wherein the social media is selected singly or in combination from the group comprising but not limiting to Facebook, Twitter, LinkedIn, Google+, Path, MySpace, Pinterest, browsers, and search engines.
